(19) United States
(12) Patent Application Publication
(10) Pub. No.: US 2007/0124572 A1
(43) Pub. Date: May 31, 2007

(54) Method and apparatus for private storage space on a storage device

(75) Inventor: Richard Coulson, Portland, OR (US)

Correspondence Address: LeMoine Patent Services, PLLC;C/O PortfolioIP, P.O. Box 52050, Minneapolis, MN, 55402, US

(73) Assignee: Intel Corporation

(21) Appl. No.: 11/290,352

(22) Filed: Nov. 30, 2005

(51) Int. Cl. G06F 15/177

(52) U.S. Cl. 713/1

(57) ABSTRACT

A storage device includes a private storage space. A storage driver component provides an interface to the storage device and hides the existence of the private storage space.

### FIELD

The present invention relates generally to electronic systems, and more specifically to storage devices in electronic systems.

### BACKGROUND

Storage devices in electronic systems are used to store data. For example, a hard disk drive is an example of a storage device in an electronic system such as a computer. Data is typically written to, and read from, a storage device using software designed specifically for the task. For example, “driver” software may provide an interface that allows other software to interact with a storage device. Typical interactions with a storage device include performing write operations, read operations, and determining the total available storage space.

### BRIEF DESCRIPTION OF THE DRAWINGS

FIG. 1 shows a block diagram of an operating system, a storage driver component, and a storage device;

FIG. 2 shows a private storage location on a hard disk platter;

FIGS. 3-5 show flowcharts in accordance with various embodiments of the present invention; and

FIG. 6 shows a system diagram in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

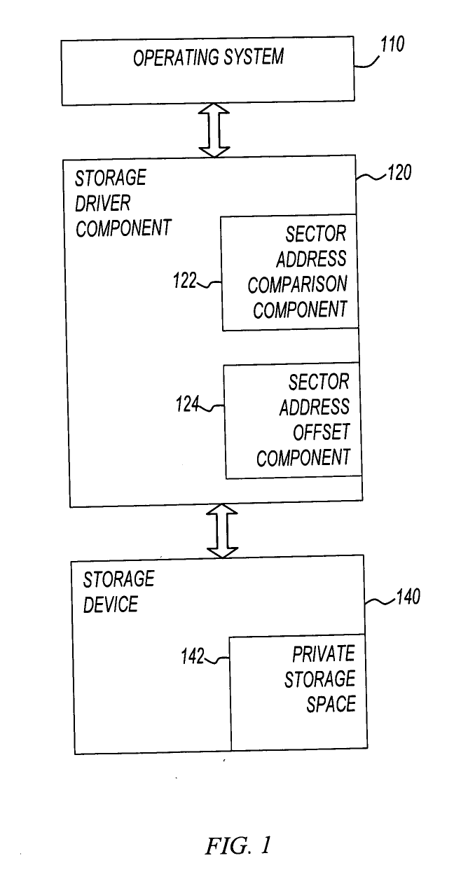

FIG. 1 shows a block diagram of an operating system, a storage driver component, and a storage device. Storage device 140 may be any type of storage device capable of storing data. For example, in some embodiments of the present invention, storage device 140 may be a hard disk drive. In other embodiments, storage device 140 may be a solid state device such as a memory device.

Storage driver component 120 provides an interface to storage device 140. For example, operating system (OS) 110 may access storage device 140 by providing commands to storage driver component 120. Storage driver component 120 may respond to commands to read data from storage device 140, write data to storage device 140, report the capacity of storage device 140, and the like.

Storage driver component 120 may be implemented as a device driver in software. Storage driver component 120 includes sector address comparison component 122 and sector address offset component 124, which also may implemented as software within a device driver. Sector address comparison component 122 and sector address offset component 124 are described more fully below.

Operating system 110 may be any type of operating system. For example, OS 110 may be an operating system running on a personal computer, a workstation, a server, a handheld device, a mobile telephone, or the like. In some embodiments, OS 110 is a commercial operating system such as those available from Microsoft, and in other embodiments, OS 110 is an open source operating system such as Linux.

As shown in FIG. 1, storage device 140 includes private storage space 142. Private storage space 142 is a portion of storage device 140 that is reserved for use by storage driver component 120. Private storage space 142 may be located anywhere within or on storage device 140. For example, private storage space 142 may be located at a lowest addressable portion on storage device 140. Also for example, private storage space 142 may be located at a highest addressable portion on storage device 140. Still further, in some embodiments, private storage space 142 may be located at any point between the lowest addressable portion and the highest addressable portion on storage device 140.

Storage driver component 120 may hide the existence of private storage space 142 from OS 110. Storage driver component 120 may use sector address comparison component 122 and sector address offset component 124 to hide the existence of private storage space 142. For example, OS 110 may provide a read or write command to storage driver component 120 to read or write data from/to storage device 140. The read or write command may include a sector address to address one or more locations with storage device 140. Sector address comparison component 120 may then compare the sector address provided by OS 110 with a sector address of private storage space 142. After making the comparison, sector address offset component 124 may conditionally add a sector address offset to the sector address provided by OS 110 before accessing storage device 140.

Private storage space 142 may be any size. The sector address offset may be determined by the size of private storage space 142. For example, if 512 megabytes (MB) of storage are reserved for private storage space 142 and each sector is 512 bytes in size, then the sector address offset may be determined as 2²⁰, or 1048576.

Private storage space 142 may have many different uses. For example, in some embodiments, a sequential copy of data required at boot time may be stored in private storage space 142 for significantly faster retrieval transparent to OS 110. In some embodiments, storage device 140 is a hard disk drive, and sequential storage of boot data on the hard disk drive provides fast retrieval.

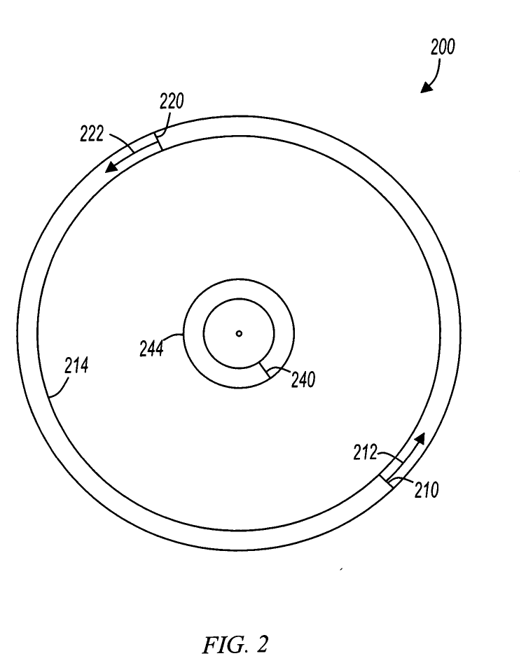

FIG. 2 shows a private storage space on a hard disk platter. Hard disk platter 200 is shown having concentric tracks 214 and 244. Track 214 is an outermost track and track 244 is an innermost track. The beginning of track 214 is shown at 210. In some embodiments, the beginning of track 214 has a sector address of zero, and represents the lowest addressable portion of the hard disk. Sector addresses increase along track 214 in the direction of arrow 212. Track 244 is an innermost track, and the end of track 244 is shown at 240. The sector address at the end of track 244 represents the highest addressable portion of the hard disk.

Although only two tracks are shown explicitly in FIG. 2, hard disk platter 200 may have any number of tracks. For example, any number of concentric tracks may be included between tracks 214 and 244 on hard disk platter 200. In addition, hard disk platter 200 may have any number of sectors. Although a single hard disk platter is shown in FIG. 2, this is not a limitation of the present invention. For example, hard disk 200 may include many platters, and may have any number of sectors. In some embodiments, logical sectors or blocks are mapped to tracks and sectors on the hard disk. Accordingly, hard disk 200 may represent physical entities such as tracks or sectors, and may also represent logical entities such as logical sectors or blocks.

A private storage space may be created anywhere on hard disk 200. For example, in some embodiments, a private storage space may be created starting at the lowest addressable portion of the hard disk, shown at 210. In these embodiments, the sector address offset component 124 (FIG. 1) may always add a sector address offset to a sector address prior to accessing hard disk 200. Also for example, a private storage space may be created starting at the sector shown at 220 and occupying space in the direction of arrow 222. In these embodiments, the sector address comparison component 122 (FIG. 1) determines whether a disk access is occurring before or after the sector located at 220, and conditionally adds the sector address offset prior to accessing hard disk 200.

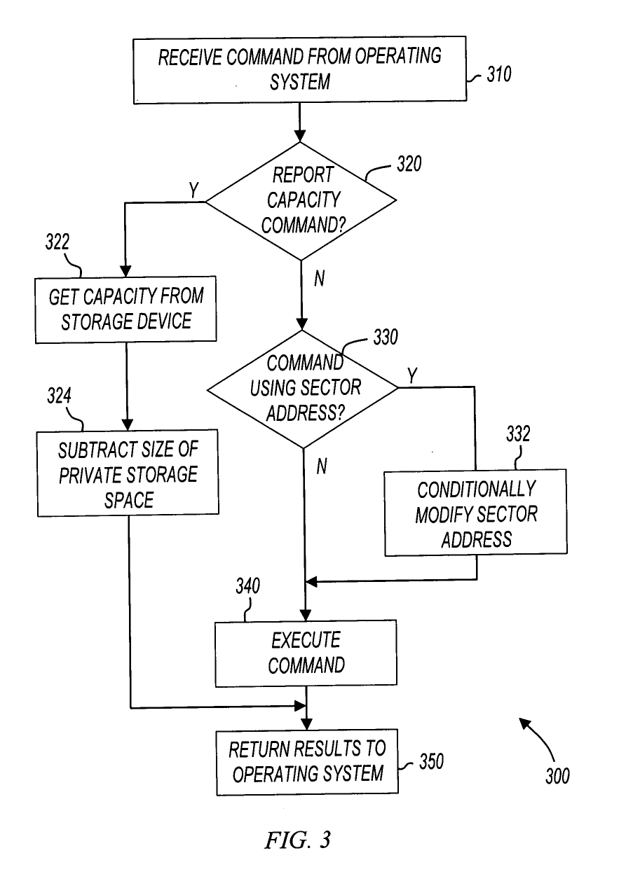

FIG. 3 shows a flowchart in accordance with various embodiments of the present invention. In some embodiments, method 300, or portions thereof, is performed by an electronic system or a processor, embodiments of which are shown in the various figures. In other embodiments, method 300 is performed by a storage driver component such as storage driver component 120 (FIG. 1). Method 300 is not limited by the particular type of apparatus or software element performing the method. The various actions in method 300 may be performed in the order presented, or may be performed in a different order. Further, in some embodiments, some actions listed in FIG. 3 are omitted from method 300.

Method 300 is shown beginning with block 310 in which a command is received from an operating system. In some embodiments, this may correspond to storage driver component 120 receiving a command from operating system 110. At 320, a determination is made whether the command is asking for the capacity of the storage device. For example, an operating system may query a storage driver to determine the total capacity or remaining capacity of a storage device to which the storage driver provides an interface.

If the command is a report capacity command, method 300 retrieves the capacity from the storage device at 322, and subtracts the size of the private storage space at 324. In some embodiments, the size of the private storage space is equivalent to the sector address offset as described above. After subtracting the size of the storage space at 324, method 300 returns the results to the operating system at 350. The portion of method 300 just described illustrates one aspect of how a storage driver can hide the existence of a private storage space from an operating system. The storage driver component reserves the private space, and reports a correspondingly smaller capacity to the operating system.

If the command is determined to not be a report capacity command at 320, method 300 determines at 330 if the command uses a sector address. If the command does not use a sector address, then the command is executed at 340, and results are returned at 350. If, on the other hand, the command does use a sector address, then method 300 conditionally modifies the sector address at 332 prior to executing the command at 340 and returning results to the operating system at 350.

Examples of commands that might use a sector address include write commands and read commands. A write command may include a sector address to indicate a sector to which data should be written. Likewise, a read command may include a sector address to indicate a sector from which data should be read. If a sector address points to a sector that occurs before a starting sector for a private storage space, then the sector address is not modified at 322 prior to executing the command at 340. If a sector address points to a sector that occurs at or after a starting point for a private storage space, then the sector address is offset by a number of sectors equal to the size of the private storage space prior to executing the command. By conditionally modifying the sector address, a storage driver may hide the existence of a private storage space from an operating system.

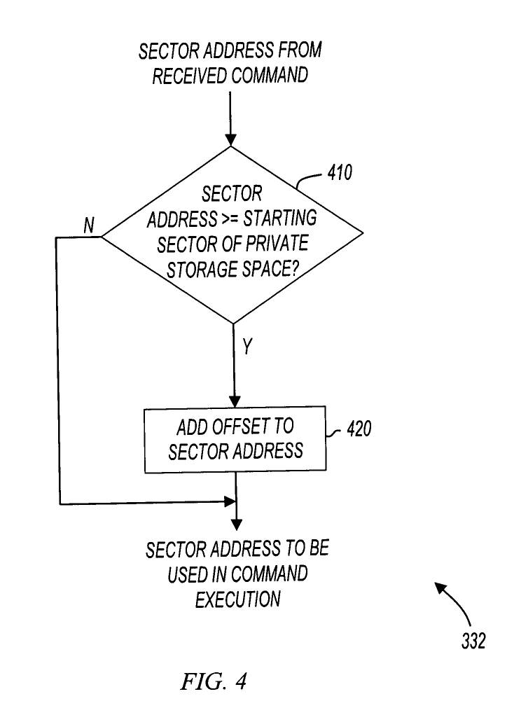

FIG. 4 shows a flowchart in accordance with various embodiments of the present invention. The actions shown in FIG. 4 represent actions that may be taken at 332 in FIG. 3. For example, at 410, a sector address from a received command is compared to a starting sector of a private storage space. If the sector address is greater than or equal to the starting sector of the private storage space, then an offset is added to the sector address at 420. If the sector address is less than the starting sector of the private storage space, than an offset is not added to the sector address.

The actions of 410 may be performed by sector address comparison component 122 (FIG. 1), and the actions of 420 may be performed by sector address offset component 124 (FIG. 1). In some embodiments, these components are implemented within a storage driver component that is implemented in software. In other embodiments, these components are implemented in hardware and/or firmware within a hard disk controller.

The term “sectors” has been used in this description in the context of hard disk storage devices, but this is not a limitation of the present invention. For example, in embodiments that utilize solid state memory, the term “sectors” may be replaced with “locations” or “blocks.” The terminology has been chosen to be illustrative, and is not meant to be construed as limiting in any manner.

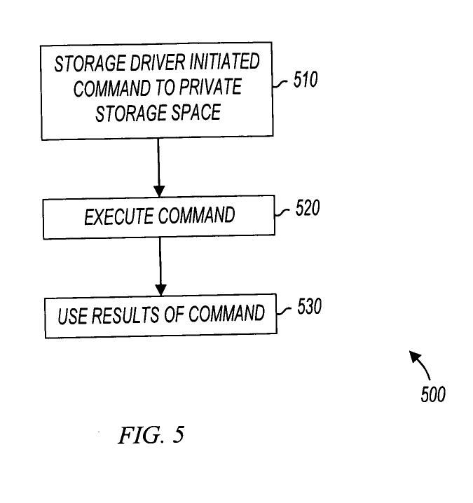

FIG. 5 shows a flowchart in accordance with various embodiments of the present invention. In some embodiments, method 500, or portions thereof, is performed by an electronic system or a processor, embodiments of which are shown in the various figures. In other embodiments, method 500 is performed by a storage driver component such as storage driver component 120 (FIG. 1). Method 500 is not limited by the particular type of apparatus or software element performing the method. The various actions in method 500 may be performed in the order presented, or may be performed in a different order. Further, in some embodiments, some actions listed in FIG. 5 are omitted from method 500.

Method 500 is shown beginning with block 510 in which a command that influences the private storage space is initiated by the storage driver. This may correspond to storage driver component 120 (FIG. 1) initiating a read from, or a write to, private storage space 142. For example, a storage driver component may store a copy of boot data stored in a sequential manner in a private storage space to decrease boot time of an electronic system. The storage driver component may initiate commands to write the boot data to the private storage space. The storage driver may also initiate commands to read the boot data from the private storage space. At 520, the command is executed, and at 530, the results of the command are used.

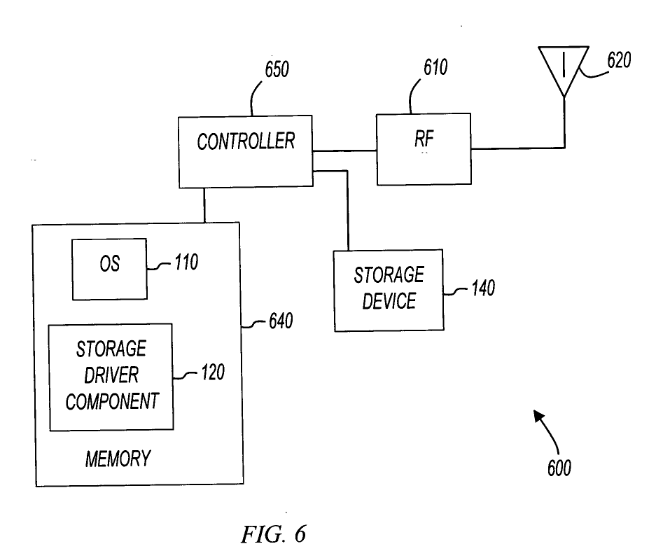

FIG. 6 shows a system diagram in accordance with various embodiments of the present invention. System 600 includes controller 650, memory 640, storage device 140 and memory 640. System 600 may include more functional blocks or subsystems than are shown in FIG. 6. For example, system 600 may include a display, power supply, wired or wireless interface, or the like. In some embodiments, controller 650 is an integrated circuit that includes many components. For example, controller 650 may include a processor, a memory controller, and an input/output (I/O) controller. Also for example, controller 650 may include multiple integrated circuits. Further, in some embodiments, controller 650 may include only a processor, I/O controller, hard disk controller, or the like.

Memory 640 represents any type of memory suitable for program or data storage. For example, memory 640 may include random access memory (RAM), read only memory (ROM), volatile memory such as static random access memory (SRAM), nonvolatile memory such as FLASH memory, or any other type of memory. Memory 640 may also represent removable media. Further, memory 640 may represent an apparatus having a medium upon which program instructions may be stored. For example, memory 640 may store program instructions that are executable by controller 650 or a component within controller 650.

Memory 640 is shown holding operating system (OS) 110 and storage driver component 120. Operating system 110 and storage driver component 120 are described above with reference to FIG. 1. Further, the operation of storage driver component 120 is described with reference to FIGS. 3-5, above. In some embodiment, OS 110 and storage driver component 120 are held on storage device 140. For example, in some embodiments, storage device 140 may be a hard disk drive, and the contents of memory 640 may be held in the hard disk drive.

Storage device 140 is described above with reference to FIG. 1. Storage device 140 includes a private storage space that is accessible by storage driver component 120. Storage device 120 may be any type of mass storage device. For example, mass storage device 120 may be a hard disk drive, an optical drive, a removable magnetic media drive, a redundant array of hard disk drives, a tape drive, or any other type of mass storage device.

RF circuits 610 may include amplifiers and demodulators. In operation, RF circuits 610 receive communications signals from antenna 620, and provide digital signals to controller 650 for processing. For ease of illustration, frequency conversion, demodulation, analog-to-digital conversion, and other signal processing is not shown. In some embodiments, RF circuits 610 may include a heterodyne receiver, and in other embodiments, RF circuits 610 may include a direct conversion receiver. In some embodiments, RF circuits 610 may include multiple receivers. For example, in embodiments with multiple antennas 620, each antenna may be coupled to a corresponding receiver.

RF circuits 610 may be adapted to receive and demodulate signals of various formats and at various frequencies. For example, RF circuits 610 may be adapted to receive time domain multiple access (TDMA) signals, code domain multiple access (CDMA) signals, global system for mobile communications (GSM) signals, orthogonal frequency division multiplexing (OFDM) signals, multiple-input-multiple-output (MIMO) signals, spatial-division multiple access (SDMA) signals, or any other type of communications signals. The various embodiments of the present invention are not limited in this regard.

In some embodiments, RF circuits 610 implement the radio frequency portion of a network interface. For example, in some embodiments, system 600 maybe a laptop computer, and RF circuits 610 are part of a wireless network interface. In other embodiments, system 600 may be a desktop computer, and RF circuits 610 are part of a wireless network interface.

Antenna 620 may include one or more antennas. For example, antenna 620 may include a single directional antenna or an omni-directional antenna. As used herein, the term omni-directional antenna refers to any antenna having a substantially uniform pattern in at least one plane. For example, in some embodiments, antenna 620 may include a single omni-directional antenna such as a dipole antenna, or a quarter wave antenna. Also for example, in some embodiments, antenna 620 may include a single directional antenna such as a parabolic dish antenna or a Yagi antenna. In still further embodiments, antenna 620 includes multiple physical antennas. For example, in some embodiments, multiple antennas are utilized for multiple-input-multiple-output (MIMO) processing or spatial-division multiple access (SDMA) processing.

Example systems represented by FIG. 6 include cellular phones, personal digital assistants, wireless local area network interfaces, notebook computers and the like. Many other systems uses exist for private storage spaces in storage devices, and storage driver components to access the private storage spaces. For example, private storage spaces in storage devices may be used in a desktop computer, a network bridge or router, or any system without an antenna.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A method comprising:
reserving a portion of a storage device to create a private storage space for use by a storage driver; and
when responding to commands from an operating system, hiding the existence of the private storage space from the operating system.

2. The method of claim 1 wherein responding to calls made by an operating system comprises receiving a sector address from the operating system, and modifying the sector address prior to accessing the storage device.

3. The method of claim 2 wherein modifying the sector address comprises adding an offset value to the sector address.

4. The method of claim 1 wherein responding to calls made by an operating system comprises responding to a command to report a capacity of the storage device.

5. The method of claim 4 wherein responding to a command to report a capacity of the storage device comprises getting an actual capacity of the storage device and subtracting a size of the private storage space.

6. The method of claim 1 further comprising storing boot data in the private storage space.

7. The method of claim 6 wherein the boot data is stored in a sequential manner to reduce boot time.

8. The method of claim 1 wherein the private storage space is reserved at a lowest addressable portion of the storage device.

9. The method of claim 1 wherein the private storage space is reserved at a highest addressable portion of the storage device.

10. An article comprising:
a machine-readable medium adapted to hold instructions that when accessed result in a machine reserving a portion of a storage device to create a private storage space for use by a storage driver, and hiding the existence of the private storage space from an operating system.

11. The article of claim 10 wherein hiding the existence of the private storage space from an operating system comprises receiving a sector address from the operating system, and modifying the sector address prior to accessing the storage device.

12. The article of claim 11 wherein modifying the sector address comprises adding an offset value to the sector address.

13. The article of claim 10 wherein hiding the existence of the private storage space from an operating system comprises responding to a command from the operating system to report a capacity of the storage device.

14. The article of claim 13 wherein responding to a command from the operating system to report a capacity of the storage device comprises getting an actual capacity of the storage device and subtracting a size of the private storage space.

15. The article of claim 10 wherein hiding the existence of the private storage space from an operating system comprises:
responding to a command from the operating system to perform a write operation at a sector address; and
modifying the sector address prior to performing the write operation.

16. The article of claim 10 wherein hiding the existence of the private storage space from an operating system comprises:
responding to a command from the operating system to perform a read operation at a sector address; and
modifying the sector address prior to performing the read operation.

17. An electronic system comprising:
an antenna;
a storage device;
a controller coupled to the antenna and the storage device; and
a storage driver component to perform read and write operations on the storage device, and to create a private storage space on the storage device for use by the storage driver component.

18. The electronic system of claim 17 wherein the storage driver component includes a sector address comparison component to compare a sector address received from an operating system against a starting sector address for the private storage space.

19. The electronic system of claim 17 wherein the storage driver component includes a sector address offset component to modify a sector address received from an operating system during read and write operations.

20. The electronic system of claim 17 wherein the private storage space is created at a lowest addressable portion of the storage device.

21. The electronic system of claim 17 wherein the private storage space is created at a highest addressable portion of the storage device.
